(19) United States
(12) Patent Application Publication
(10) Pub. No.: US 2014/0170451 A1
(43) Pub. Date: Jun. 19, 2014

(54) ELECTRODE

(71) Applicant: KABUSHIKI KAISHA TOSHIBA, MINATO-KU (JP)

(72) Inventors: Takuya IWASAKI, Uenohara-shi (JP); Yasuhiro Harada, Yokohama-shi (JP); Hiroki Inagaki, Yokohama-shi (JP); Norio Takami, Yokohama-shi (JP)

(73) Assignee: KABUSHIKI KAISHA TOSHIBA, MINATO-KU (JP)

(21) Appl. No.: 14/132,724

(22) Filed: Dec. 18, 2013

(30) Foreign Application Priority Data
Dec. 18, 2012 (JP) 2012-276128

(51) Int. Cl. H01M 4/70; H01M 10/48; H01M 2/24

(52) U.S. Cl. CPC H01M 4/70; H01M 2/24; H01M 10/482
USPC 429/90; 429/233; 429/245; 429/211; 429/156; 429/158

(57) ABSTRACT

According to one embodiment, there is provided an electrode. The electrode includes an active material-containing layer and a current collector. The current collector includes first and second regions. The first region has a surface roughness Ra₁. The second region has a surface roughness of Ra₂. The active material-containing layer is supported by the second region. The surface roughness Ra₁ of the first region is smaller than the surface roughness of Ra₂ of the second region.

### CROSS-REFERENCE TO RELATED APPLICATIONS

This application is based upon and claims the benefit of priority from the Japanese Patent Application No. 2012-276128, filed Dec. 18, 2012, the entire contents of which are incorporated herein by reference.

### FIELD

Embodiments described herein relate generally to an electrode, a battery and a battery pack.

### BACKGROUND

Lithium ion nonaqueous electrolyte batteries are, as high-energy density batteries, widely used in various fields, such as electric vehicles, electricity storage systems, and information equipment. Along with the widespread use thereof, there is an increasing need for lithium ion nonaqueous electrolyte batteries in the market and the studies thereof have been actively progressed.

Among them, in order to allow the use as a power source for electric vehicles, a lithium ion nonaqueous electrolyte battery is required to have a high energy density, i.e., a high discharge capacity per unit weight or unit volume. And, in order to regenerate the kinetic energy at the time of deceleration, the lithium ion nonaqueous electrolyte battery used as a power source for electric vehicles is required to be charged efficiently even if a large current is input to the battery. Further, the lithium ion nonaqueous electrolyte battery used as a power source for electric vehicles is required to discharge a large output power (i.e., a large current) instantaneously at the time of starting, sudden starting, or sudden acceleration of an electric vehicle. Thus, the lithium ion nonaqueous electrolyte battery as a power source for electric vehicles is desired to have a large capacity and good input-output characteristics in a short time.

As a negative electrode active material of the lithium ion nonaqueous electrolyte battery, a carbon-based material is mainly used. Further, a spinel-type lithium titanate having a high potential of Li-absorption and release as compared with the carbon-based material and a titanium composite oxide TiO₂ (B) having a monoclinic system β type structure which is one of the crystal structures of TiO₂ as a high capacity negative electrode material is promising as a negative electrode active material for lithium ion nonaqueous electrolyte batteries.

Accompanied with this, technology development related to a technique of mixing and/or kneading these active materials with a conductive aid or a binder or a technique of applying a slurry containing an active material to a current collector has been actively performed in aspects of materials and processes. Particularly, the binding strength of an active material-containing layer to the current collector largely contributes to the long-term reliability of the electrode. Thus, this is particularly attracting the attention. Under such circumstances, a technique of roughening the surface of a current collector by electrolytic etching is used in order to increase the specific surface area of the current collector and improve the binding strength.

If an electrolytic foil is used as the current collector, the specific surface area of the current collector is relatively increased as compared with the current collector whose surface is not roughened. Thus, if the slurry containing an active material is applied to the electrolytic foil as a current collector and dried, the binding property of the active material-containing layer with the current collector is improved.

However, on the other hand, if a portion in which the slurry is not applied on the electrolytic foil used as the current collector is used as an electrode tab, it is difficult to mutually weld the electrode tabs by even ultrasonic welding due to influences of the surface unevenness by electrolytic etching. Thus, it is difficult to overlap a plurality of the electrode tabs and join them by applying ultrasonic wave so as to increase the battery capacity.

If the thickness of the electrolytic foil used as the current collector is decreased in order to increase the battery capacity, the electrolytic foil is easily broken when performing ultrasonic welding at high power. If ultrasonic welding is performed at low power in order to prevent the electrolytic foil from being broken, the join strength of the ultrasonic-welded portion becomes low. As a result, the contact resistance of the welded portion is increased and the battery performance may be reduced. Further, the battery subjected to such an ultrasonic welding is lack of long-term reliability of joining of electrode tabs. For example, in such a battery, when vibration is applied from the outside, the joined portions are disconnected, energization may not continue.

### BRIEF DESCRIPTION OF THE DRAWINGS

FIG. 1 is a schematic partially cut perspective view of a battery of an example according to a second embodiment;

FIG. 2 is a schematic cross-sectional view along a line segment II-II′ of an electrode group included in the battery shown in FIG. 1;

FIG. 3A is a schematic plan view of a positive electrode included in the battery shown in FIG. 1;

FIG. 3B is a cross-sectional view of the positive electrode included in the battery shown in FIG. 1;

FIG. 4 is a schematic view showing another example of the electrode group included in the battery according to the second embodiment;

FIG. 5 is a schematic development perspective view of another example of the battery according to the second embodiment;

FIG. 6 is a schematic exploded perspective view of an example of a battery pack according to a third embodiment; and

FIG. 7 is a block diagram showing an electric circuit of the battery pack shown in FIG. 6.

### DETAILED DESCRIPTION

In general, according to one embodiment, there is provided an electrode including an active material-containing layer and a current collector. The current collector includes first and second regions. The first region has a surface roughness Ra₁. The second region and has a surface roughness of Ra₂. The active material-containing layer is supported by the second region. The surface roughness Ra₁ of the first region is smaller than the surface roughness of Ra₂ of the second region.

The embodiments will be explained below with reference to the drawings. In this case, the structures common to all embodiments are represented by the same symbols and duplicated explanations will be omitted. Also, each drawing is a typical view for explaining the embodiments and for promoting the understanding of the embodiments. Though there are parts different from an actual device in shape, dimension and ratio, these structural designs may be properly changed taking the following explanations and known technologies into consideration.

### First Embodiment

According to a first embodiment, there is provided an electrode including an active material-containing layer and a current collector. The current collector includes first and second regions on its surface (excluding an end surface). The first region does not support the active material-containing layer and has a surface roughness Ra₁. The second region supports the active material-containing layer and has a surface roughness of Ra₂. The surface roughness Ra₁ of the first region is smaller than the surface roughness of Ra₂ of the second region.

The surface roughness of the current collector can be measured by, for example, using the method specified in JIS B 0031:2003.

The surface roughness Ra₁ of the first region not supporting the active material-containing layer is smaller than the surface roughness Ra₂ of the second region supporting the active material-containing layer. Since the surface roughness of the first region is small, the first regions of a plurality of the current collectors can be joined together at sufficient strength, even if the low power for ultrasonic welding is applied. Therefore, if the portion whose surface is the first region of the current collector according to the first embodiment is used as the electrode tab, the reliability of connection between the electrode tabs can be improved. A battery which comprises an electrode comprising the current collector including the first region on the surface can suppress an increase in contact resistance and improve long-term connection reliability.

On the other hand, the surface roughness Ra₂ of the second region supporting the active material-containing layer is larger than the surface roughness Ra₁ of the first region not supporting the active material-containing layer. Since the surface roughness of the second region of the current collector is large, the binding property with the active material-containing layer supported thereon can be improved. If a battery is produced using an electrode comprising the current collector including the second region on the surface, it is possible to provide a battery which is excellent in the binding property of the current collector with the active material-containing layer and thus is excellent in battery characteristics such as output characteristics, rapid charge characteristics, and charge and discharge cycle characteristics.

Preferably, a current collector thickness T₁ of the first region is smaller than a current collector thickness T₂ of the second region. The current collector thickness of the first region is the thickness of the portion whose surface is the first region of the current collector. Similarly, the current collector thickness of the second region is the thickness of the portion whose at least one surface is the second region of the current collector.

As for the current collector in which the current collector thickness T₁ of the first region is smaller than the current collector thickness T₂ of the second region, the first region which functions as an electrode tab is rich in flexibility. Thus, it is easy to assemble a plurality of electrode tabs into one. Thus, in such an electrode, ultrasonic welding of electrode tabs can be performed more easily and more firmly. If the electrode is used, it is possible to provide a battery in which electrode tabs are more firmly joined.

In the current collector, the current collector thickness T₁ of the first region is smaller than the current collector thickness T₂ of the second region supporting the active material-containing layer. Thus, it is possible to press the active material-containing layer supported by the second region without suffering the interference of the first region. Accordingly, the electrode comprising such a current collector can densify the active material-containing layer supported by the second region easily. Therefore, in the case of a battery comprising such an electrode, it is possible to easily achieve an improvement in battery capacity.

The surface roughness Ra₁ of the first region is preferably not less than 0.01 μm but not more than 0.4 μm. In the current collector including the first region having the surface roughness Ra₁ in this range, it is possible to perform the ultrasonic welding among the first regions at lower power levels.

The surface roughness of Ra₂ of the second region is preferably more than 0.4 μm but not more than 5 μm. The current collector including the second region having the surface roughness Ra₂ in this range can improve the adhesion with the active material-containing layer supported on the second region. Therefore, if an electrode comprising the current collector including such a second region is used, it is possible to provide a battery having more excellent battery characteristics such as output characteristics, rapid charge characteristics, and charge and discharge cycle characteristics.

The shapes of the first and second regions of the current collector can be freely designed according to the desired battery, particularly, the shape of the electrode group.

As the current collector, it is preferable to use an electrolytically-etched foil.

The current collector is not limited and can include (a) a metal, (b) stainless steel, (c) an alloy or (d) a clad foil. Examples of the metal which can be included in the current collector include at least one metal selected from the group consisting of aluminum, copper, nickel, titanium, and iron. Examples of the stainless steel which can be included in the current collector include SUS304. Examples of the alloy which can be included in the current collector include an alloy containing at least one selected from the group consisting of aluminum, copper, nickel, titanium, and iron. Examples of the clad foil which can be included in the current collector include a clad foil containing at least one selected from the group consisting of aluminum, copper, nickel, titanium, iron, and stainless steel.

As the material of the current collector, it is preferable to use an aluminum foil or aluminum alloy foil, for example, from the viewpoint of production cost, conductivity, and weight. As the aluminum foil, it is preferable to use one having a purity 99% by mass or more. In the case in which an aluminum alloy is used as the current collector, it is preferable to use an alloy containing an element such as magnesium, zinc or silicon. As for the aluminum alloy, the content of transition metals such as iron, copper, nickel, and chromium is preferably 1% by mass or less.

The thickness of the current collector is preferably 20 μm or less from the viewpoint of battery capacity. The thickness of the current collector is more preferably 15 μm or less. As described above, in the electrode according to the first embodiment, the surface roughness Ra₁ of the first region of the current collector is small. Thus, the first regions of a plurality of the current collectors can be joined together at sufficient strength even if the ultrasonic welding at low power is performed. That is, in the electrode according to the first embodiment, even if the thickness of the current collector is 20 μm or less, the first regions can be joined together at sufficient strength by ultrasonic welding without breaking the current collector.

The current collector preferably has an average crystal grain size of 50 μm or less. The current collector having an average crystal grain size in this range can increase the strength. Thus, a high pressure can be applied to an electrode comprising such a current collector, and densification, i.e., an increase in battery capacity can be achieved. Even if the electrode comprising the current collector having an average crystal grain size of 50 μm or less is exposed to the over-discharge cycle in the hot environment (at 40° C. or more), it is possible to prevent the deterioration of the current collector due to dissolution or corrosion. Accordingly, in the electrode comprising the current collector having an average crystal grain size of 50 μm or less, when being exposed to the over-discharge cycle in the hot environment (at 40° C. or more), an increase in electrode impedance can be suppressed. The average crystal grain size of the current collector is more preferably 30 μm or less, still more preferably 5 μm or less.

The average crystal grain size can be calculated as follows. The structure of the surface of the current collector is observed with an optical microscope and a crystal grain number n present in a region of 1 mm×1 mm is calculated. An average crystal grain area S is calculated by plugging the number n into the equation: S(μm²)=1×10⁶/n. An average crystal grain size d(μm) is calculated by plugging the obtained value of S into Equation (1) below.

d=₂(S/π)^{1/2} (1)

The average crystal grain size of the current collector is intricately influenced by many factors such as composition of materials, impurities contained in the material, processing conditions, heat treatment histories, and annealing conditions. The current collector having an average crystal grain size of 50 μm can be prepared by adjusting the combination of the above-described various-factors during the production process.

The active material-containing layer included in the electrode according to the first embodiment can comprise an active material, a conductive agent, and a binder. Materials which can be included in the active material-containing layer will be described in detail in the second embodiment.

The electrode according to the first embodiment can be used as a positive or negative electrode of a battery or as both the positive and negative electrodes. If the electrode according to the first embodiment is used as the positive and negative electrodes of the battery, it is possible to improve both the joining reliability of positive electrode tabs and the joining reliability of negative electrode tabs. In this case, the binding property of the current collector with the active material-containing layer can be improved in both the positive electrode and the negative electrode. As a result, it is also possible to further improve battery characteristics of the battery such as output characteristics, rapid charge characteristics, and charge and discharge cycle characteristics.

The electrode according to the first embodiment can be produced by, for example, the following method.

First, the surface of the metal foil is roughened. As the metal foil, it is possible to use the materials listed as materials which can be included in the current collector. The surface roughening of the metal foil can be performed by, for example, anodizing the metal foil to obtain an electrolytically-etched foil.

Subsequently, a part of the electrolytically-etched foil obtained by anodic oxidation of the metal foil is pressed so that a first region corresponding to the pressed portion and a second region having a surface roughness larger than that of the first region can be obtained. If the method is used, it is possible to produce a current collector in which the current collector thickness T₁ of the first region is smaller than the current collector thickness T₂ of the second region.

On the other hand, an active material, a conductive agent, and a binder are suspended in an appropriate solvent to prepare slurry. The slurry thus prepared is applied to only the second region of the current collector obtained by the method described above. Alternatively, the slurry is applied to a part including the second region of the surface of the current collector or the whole surface of the current collector. Thereafter, the applied slurry is removed so as to leave the applied portion on the second surface. Thus, it is possible to obtain a current collector in which the slurry is not applied to the first region and the slurry is applied to the second region.

Subsequently, the slurry applied to the second region of the current collector is dried so that the active material-containing layer can be obtained. Thereafter, the active material-containing layer thus obtained is pressed so that the electrode according to the first embodiment can be obtained.

The electrode according to the first embodiment can be produced by not only the above production methods but also various methods such as modified methods of the above ones.

For example, the electrode according to the first embodiment can be produced by allowing the active material-containing layer to be supported by a part of electrolytically-etched foil and pressing a portion not supporting the active material-containing layer. Even if the method is used, it is also possible to produce a current collector in which the current collector thickness T₁ of the first region is smaller than the current collector thickness T₂ of the second region.

Further, the surface roughening of the metal foil can be also performed by mechanically roughening a part of the surface of the metal foil.

As the active material-containing layer, one obtained by shaping an active material, a conductive agent, and a binder into a pellet form can also be used.

As described above, in the battery according to the first embodiment, since the surface roughness of the first region not supporting the active material-containing layer of the current collector is small, the first regions of a plurality of the current collectors can be joined together at sufficient strength, even if the low power for ultrasonic welding is applied. Therefore, if the portion whose surface is the first region of the current collector according to the first embodiment is used as the electrode tab, the reliability of connection between the electrode tabs can be improved. A battery which comprises an electrode comprising the current collector including such a first region on the surface can suppress an increase in contact resistance and improve long-term connection reliability.

On the other hand, since the surface roughness of the second region supporting the active material-containing layer is large, the binding property of the current collector with the active material-containing layer supported thereon can be improved. If a battery is produced using an electrode including the current collector including such a second region on the surface, it is possible to provide a battery which is excellent in the binding property of the current collector with the active material-containing layer and thus is excellent in battery characteristics such as output characteristics, rapid charge characteristics, and charge and discharge cycle characteristics.

### Second Embodiment

According to the second embodiment, there is provided a battery including the electrode according to the first embodiment. The battery according to the second embodiment can include a plurality of the electrodes.

As described in the section of the first embodiment, if the first region of the electrode according to the first embodiment is used as the electrode tab, the reliability of connection between the electrode tabs can be improved. Thus, according to the second embodiment, there can be provided a battery which can suppress an increase in the contact resistance and is excellent in long-term connection reliability.

And, as described in the section of the first embodiment, the electrode according to the first embodiment can increase the binding property of the current collector with the active material-containing layer. Thus, according to the second embodiment, there can be provided a battery excellent in battery characteristics.

The electrode according to the first embodiment which is included in the battery according to the second embodiment may be a positive electrode or a negative electrode, or may be both the positive and negative electrodes. When the electrode according to the first embodiment is used as the positive and negative electrodes of the battery, it is possible to improve both the joining reliability of positive electrode tabs and the joining reliability of negative electrode tabs. In this case, the binding property of the current collector with the active material-containing layer can be improved in both the positive electrode and the negative electrode. As a result, it is possible to provide a battery having improved battery characteristics of the battery, such as output characteristics, rapid charge characteristics, and charge and discharge cycle characteristics.

In the current collector included in the electrode according to the first embodiment which is included in the battery according to the second embodiment, the first region can serve as an electrode tab as described in the first embodiment.

Further, the portions servings as an electrode tab can be joined to together by ultrasonic welding as described in the section of the first embodiment. Since the surface roughness of the first region is low, the first regions of a plurality of the current collectors can be joined together at sufficient strength, even if the low power for ultrasonic welding is applied. In other words, the battery in which the first regions of the current collector are joined together by ultrasonic welding can exhibit excellent reliability of joining of electrode tabs.

Hereinafter, the example of the second embodiment will be described with reference to the drawings.

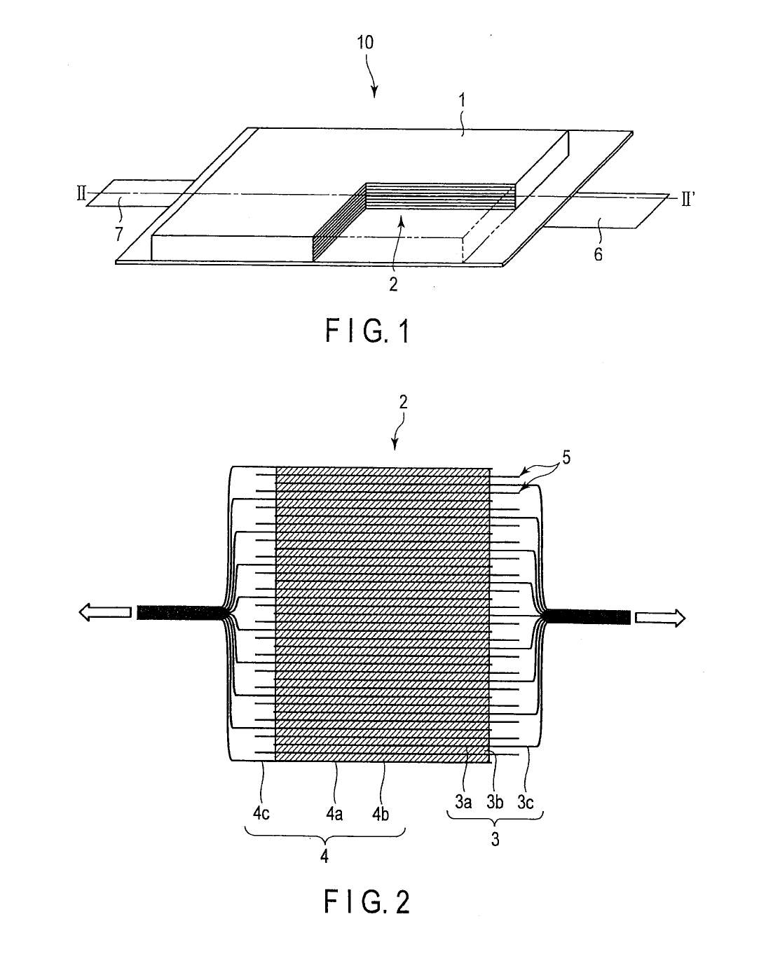

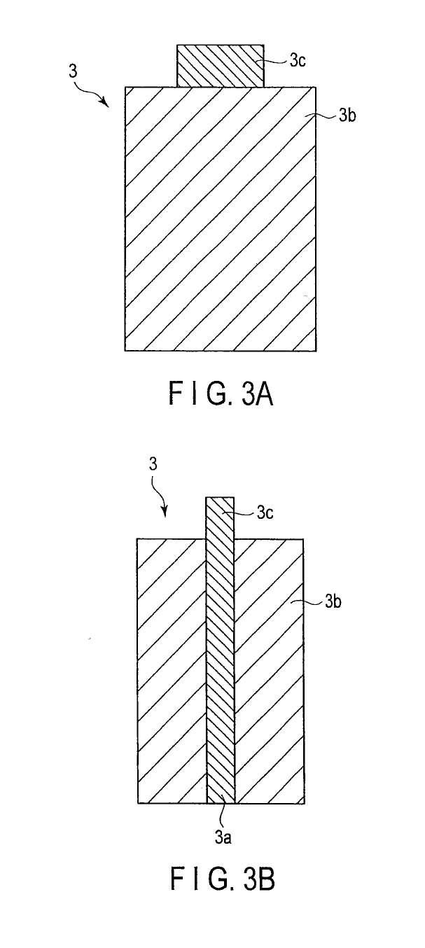

FIG. 1 is a schematic partially cut perspective view of a battery of an example according to a second embodiment. FIG. 2 is a schematic cross-sectional view along a line segment II-II′ of an electrode group included in the battery shown in FIG. 1. FIG. 3A is a schematic plan view of a positive electrode included in the battery shown in FIG. 1. FIG. 3B is a cross-sectional view of the positive electrode included in the battery shown in FIG. 1.

A battery 10 shown in FIGS. 1 and 2 comprises a case 1 formed of a laminate film, an electrode group 2 housed in the case 1, and a nonaqueous electrolyte (not shown) housed in the case 1. That is, the battery 10 shown in FIGS. 1 and 2 is a nonaqueous electrolyte battery.

The electrode group 2 comprises a plurality of positive electrodes 3 and a plurality of negative electrodes 4, as shown in FIG. 2. The electrode group 2 has a structure in which the positive electrodes 3 and the negative electrodes 4 are alternately stacked while sandwiching separators 5 therebetween, as shown in FIG. 2.

As shown in FIG. 2, each of the positive electrodes 3 comprises a positive electrode current collector 3a and a positive electrode active material containing layer 3b supported by a part of the surface of the positive electrode current collector 3a. The positive electrode current collector 3a has a rectangular main portion and a narrow portion extended from one side of the main portion and having a width smaller than that of the main portion, as shown in FIGS. 3A and 3B. The surface roughness of the main portion of the positive electrode current collector 3a is larger than the surface roughness of the narrow portion of the positive electrode current collector 3a. The main portion of the positive electrode current collector 3a supports the positive electrode active material containing layer 3b on the surface except the end face. On the other hand, the surface of the narrow portion of the positive electrode current collector 3a does not support the positive electrode active material containing layer 3b. That is, each of the positive electrodes 3 shown in FIGS. 2, 3A, and 3B is the electrode according to the first embodiment. Here, the surface of the narrow portion of the positive electrode current collector 3a is the first region, and is the positive electrode tab 3c of the positive electrode 3. The surface of the main portion of the positive electrode current collector 3a is the second region.

As shown in FIG. 2, each of the negative electrodes 4 included in the battery 10 comprises a negative electrode current collector 4a and a negative electrode active material containing layer 4b supported by a part of the surface of the negative electrode current collector 4a. Although not illustrated, the negative electrode current collector 4a has the same structure as that of the positive electrode current collector 3a, i.e., a rectangular main portion and a narrow portion extended from one side of the main portion and having a width smaller than that of the main portion. The surface roughness of the main portion of the negative electrode current collector 4a is larger than the surface roughness of the narrow portion of the negative electrode current collector 4a. The main portion of the negative electrode current collector 4a supports the negative electrode active material containing layer 4b on the surface except the end face. On the other hand, the surface of the narrow portion of the negative electrode current collector 4a does not support the negative electrode active material containing layer 4b. That is, each of the negative electrodes 4 shown in FIG. 2 is the electrode according to the first embodiment. Here, the surface of the narrow portion of the negative electrode current collector 4a is the first region and is the negative electrode tab 4c of the negative electrode 4. The surface of the main portion of the negative electrode current collector 4a is the second region.

As for the electrode group 2, it is only necessary that one active material-containing layer faces the other active material-containing layer via the separator 5 sandwiched therebetween. Thus, a portion of the negative electrode current collector 4a which does not facing the positive electrode active material-containing layer 3b via the separator 5 may not support the negative electrode active material-containing layer 4b. Similarly, a portion of the positive electrode current collector 3a which does not facing the negative electrode active material-containing layer 4b via the separator 5 may not support the positive electrode active material-containing layer 3b. Accordingly, the main portions of the positive electrode current collector 3a and the negative electrode current collector 4a can include, on their surfaces, a region which does not support the active material-containing layer, in addition to the second region. Actually, in the electrode group 2 shown in FIG. 2, the surface which is oriented outwardly of the main portion of the negative electrode current collector 4a of the negative electrode 4 located in the outermost part does not support the negative electrode active material-containing layer 4b.

The positive electrode tabs 3c of the positive electrode current collectors 3a project from the electrode group 2 and are joined in a mutually overlapped state, as shown in FIG. 2. A plurality of the positive electrode tabs 3c mutually joined are electrically connected to a beltlike positive electrode terminal 6.

The negative electrode tabs 4c of the negative electrode current collectors 4a project from the electrode group 2 and are joined in a mutually overlapped state, as shown in FIG. 2. The negative electrode tabs 4c mutually joined are electrically connected to a beltlike negative electrode terminal 7.

In the battery 10 shown in FIG. 1, the one end of the positive electrode terminal 6 and the one end of the negative electrode terminal 7 are extended from the case 1. The direction where the end of the positive electrode terminal 6 is extended from the case 1 forms an angle of 180° with the direction where the end of the negative electrode terminal 7 is extended from the case 1.

Subsequently, an example of the method of producing the positive electrode 3 having the structure shown in FIGS. 3A and 3B and the negative electrode 4 having the same structure as that of the positive electrode 3 will be described.

The positive electrode 3 and the negative electrode 4 can be produced by, for example, the following three methods: (1) a method of using a current collector obtained by punching-outa metal foil to form a piece, subjecting the piece to surface roughening, pressing a part of it; (2) a method of using a current collector obtained by subjecting a metal foil to surface roughening, pressing a part of it, and punching-out it; and (3) a method of using a current collector obtained by subjecting a metal foil to surface roughening, punching-out it, and pressing a part of it.

The method (1) can be performed, for example, as follows.

First, the metal foil is punched-out to form a metal foil including portions corresponding to main and narrow portions. Next, the metal foil including a narrow portion is subjected to surface roughening by anodic oxidation. Thereafter, the narrow portion is pressed to obtain a current collector including a first region corresponding to the pressed portion and a second region having a surface roughness larger than that of the first region. On the other hand, an active material, a conductive agent, and a binder are suspended in an appropriate solvent to prepare slurry. The slurry thus prepared is applied to only the second region of the current collector obtained as described above. As a result, the positive electrode 3 having the structure shown in FIGS. 3A and 3B and the negative electrode 4 having the same structure as that of the positive electrode 3 can be obtained.

The method (2) can be performed, for example, as follows.

First, the whole surface of the metal foil is roughened. Next, a part of the roughened metal foil is pressed to obtain a current collector including a first region corresponding to the pressed portion and a second region having a surface roughness larger than that of the first region. On the other hand, an active material, a conductive agent, and a binder are suspended in an appropriate solvent to prepare slurry. The slurry thus prepared is applied to only the second region of the current collector obtained by the method described above. Thereafter, the first region is punched-out so that a narrow portion can be formed in the first region of the current collector. As a result, the positive electrode 3 having the structure shown in FIGS. 3A and 3B and the negative electrode 4 having the same structure as that of the positive electrode 3 can be obtained.

The method (3) can be performed, for example, as follows.

First, the whole surface of the metal foil is roughened. On the other hand, an active material, a conductive agent, and a binder are suspended in an appropriate solvent to prepare slurry. The slurry thus prepared is applied to the surface of the roughened metal foil so as to form an uncoated portion. Subsequently, the uncoated portion of the metal foil is punched-out to form portions corresponding to main and narrow portions in the metal foil. Thereafter, the narrow portion is pressed to obtain a first region corresponding to the pressed portion and a second region having a surface roughness larger than that of the first region. As a result, the positive electrode 3 having the structure shown in FIGS. 3A and 3B and the negative electrode 4 having the same structure as that of the positive electrode 3 can be obtained.

Subsequently, joining of the positive electrode tabs 3c, joining of the negative electrode tabs 4c, connecting of the positive electrode tabs 3c to the positive electrode terminal 6, and connecting of the negative electrode tabs 4c to the negative electrode terminal 7 will be described.

The joining of the positive electrode tabs 3c and the joining of the negative electrode tabs 4c can be performed by, for example, ultrasonic welding.

The joining of the electrode tabs by ultrasonic welding can be performed by, for example, the following procedure. First, one ends of the positive electrode tabs 3c projected from the electrode group 2 are overlapped, and one ends of the negative electrode tabs 4c projected from the electrode group 2 are overlapped. They are fixed with a holding member, followed by ultrasonic welding in this state. As described above, the positive electrode tab 3c and the negative electrode tab 4c are the first region of the positive electrode current collector 3a and the first region of the negative electrode current collector 4a, respectively and have a small surface roughness Ra₁. Thus, joining of the positive electrode tabs 3c and joining of the negative electrode tabs 4c can be carried out with sufficient strength even if the low power for ultrasonic welding is applied.

The positive electrode tabs 3c can be connected to the positive electrode terminal 6 by an arbitrary method. For example, the positive electrode tabs 3c may be ultrasonic welded to the positive electrode terminal 6. Alternately, the positive electrode tabs 3c may be joined together, and then, they may be joined to the positive electrode terminal 6 by, for example, welding.

Similarly, the negative electrode tabs 4c can be connected to the negative electrode terminal 7 by an arbitrary method. For example, the negative electrode tabs 4c may be ultrasonic welded to the negative electrode terminal 7. Alternately, the negative electrode tabs 4c may be joined together, and then they may be joined to the negative electrode terminal 7 by, for example, welding.

Hereinafter, the positive electrode 3, the negative electrode 4, the separator 5, the nonaqueous electrolyte, the positive electrode terminal 6, the negative electrode terminal 7, and the case 1 which can be used for the battery according to the second embodiment will be described.

(1) Positive Electrode 3

As the positive electrode current collector 3a included in the positive electrode 3, one described in the first embodiment can be used.

The positive electrode active material containing layer 3b included in the positive electrode 3 can contain a positive electrode active material, a positive electrode conductive agent, and a binder.

In the positive electrode active material containing layer 3b, as for the compounding ratio of the positive electrode active material, the conductive agent, and the binder, it is preferable that the content of the positive electrode active material is from 80 to 95% by mass, the content of the conductive agent is from 3 to 18% by mass, and the content of the binder is from 2 to 17% by mass.

Various oxides, sulfides, and polymers can be used for the positive electrode active material. Examples thereof include manganese dioxide (MnO₂), iron oxide, copper oxide, and nickel oxide, and lithium manganese composite oxides (e.g., LiₓMn₂O₄ or LiₓMnO₂), lithium nickel composite oxides (e.g., LiₓNiO₂), lithium cobalt composite oxides (LiₓCoO₂), lithium nickel cobalt composite oxides (e.g., LiNi_{1-y}Co_{y}O₂), lithium manganese cobalt composite oxides (e.g., LiMn_{y}Co_{1-y}O₂), spinel-type lithium manganese nickel composite oxides (LiₓMn_{2-y}O₄), lithium phosphorus oxides having an olivine structure (LiₓFePO₄, LiₓFe_{1-y}Mn_{y}O₄, and LiₓCoPO₄), iron sulfate (Fe₂(SO₄)₃), and vanadium oxides (e.g., V₂O₅). Further, examples thereof include conductive polymer materials such as polyaniline and polypyrrole; disulfide-based polymer materials; organic materials such as carbon fluoride; sulfur (S); and inorganic materials. In this regard, x and y preferably range from 0 to 1.

Further, a lithium nickel cobalt manganese composite oxide having the composition represented by LiₐNi_{b}Co_{c}Mn_{d}O₂ (wherein molar ratios a, b, c, and d are 0≦a≦1.1, 0.1≦b≦0.5, 0≦c≦0.9, and 0.1≦d≦0.5, respectively) can be used for the positive electrode active material.

When a nonaqueous electrolyte containing room temperature molten salt is used, it is preferable to use lithium iron phosphate, liₓVPO₄F, a lithium manganese composite oxide, a lithium nickel composite oxide, and a lithium nickel cobalt composite oxide from the viewpoint of cycle life. This is because the reactivity of the positive electrode active material with room temperature molten salt is decreased.

Examples of the positive electrode conductive agent can include acetylene black, carbon black, and graphite.

Examples of a positive electrode binder include polytetrafluoroethylene (PTFE), polyvinylidene fluoride (PVdF), fluorine rubber, acrylic rubber, and acrylic resin.

Preferably, a surface roughness Ra (+) facing the separator 5 of the positive electrode active material containing layer 3b is set to be not less than 0.1 μm but not more than 0.6 μm. As a result, a wetted area with the nonaqueous electrolyte is sufficiently ensured, resulting in suppressing the side reaction by the nonaqueous electrolyte. Accordingly, it is possible to improve not only input-output characteristics, but also cycle characteristics. The surface roughness Ra (+) facing the separator 5 of the positive electrode active material-containing layer 3b is preferably from 0.15 to 0.4 μm. Here, in the measurement of the surface roughness Ra (+) of the positive electrode active material-containing layer 3b, the arithmetic mean roughness Ra specified by JIS B 0601 (1994) or JIS B 0031 (1994) is used.

Desirably, the density of the positive electrode 3 is set to 3 g/cm³ or more. This is because if the density of the positive electrode 3 is set to less than 3 g/cm³, there is a possibility that the positive electrode active material containing layer 3b having the surface roughness Ra (+) of not less than 0.1 μm but not more than 0.6 μm) may not be obtained.

(2) Negative Electrode 4

As the negative electrode current collector 4a included in the negative electrode 4, one described in the first embodiment can be used.

The negative electrode active material-containing layer 4b included in the negative electrode 4 can contain a negative electrode active material, a negative electrode conductive agent, and a binder.

In the negative electrode active material-containing layer, as for the compounding ratio of the negative electrode active material, the conductive agent, and the binder, it is preferable that the content of the negative electrode active material is from 62 to 97.5% by mass, the content of the conductive agent is from 2 to 28% by mass, and the content of the binder is from 0.5 to 10% by mass. If the content of the conductive agent is set to 2% by mass or more, high current collection performance can be obtained, resulting in excellent large current characteristics. On the other hand, for the purpose of achieving high capacity, the content of the conductive agent is preferably 28% by mass or less. If the amount of the binder is set to 0.5% by mass or more, the peel strength can be adjusted to 0.005 N/mm or more. On the other hand, the amount of the binder is set to 10% by mass or less, proper coating liquid viscosity is obtained and good coating can be carried out.

As the negative electrode active material, it is preferable to use a negative electrode active material having a Li-absorption potential of 0.4 V (vs. Li/Li⁺) or more.

In the case of an active material which absorbs lithium at a potential lower than 0.4 V (vs. Li/Li⁺) (e.g., graphite and lithium metal), if an input/output at a large current is repeated, metal lithium is precipitated on the negative electrode surface to grow in the form of a dendrite. If a negative electrode active material having a lithium absorption potential higher than 0.4 V (vs. Li/Li⁺) is used, the precipitation of metal lithium on the negative electrode surface can be suppressed. Thus, in this case, internal short circuiting during the input/output at a large current can be avoided. The upper limit of the lithium absorption potential of the negative electrode active material is preferably 3 V (vs. Li/Li⁺), more preferably 2 V (vs. Li/Li⁺).

A negative electrode active material capable of absorbing lithium within a range of 0.4 to 3 V (vs. Li/Li⁺) is preferably a metal oxide, a metal sulfide, a metal nitride or an alloy.

Examples of the metal oxide include titanium-containing metal composite oxides, tin oxides such as SnB_{0.4}P_{0.6}O_{3.1} and SnSiO₃, silicon oxides such as SiO, and tungsten oxides such as WO₃. Among them, the titanium-containing metal composite oxides are preferred.

The grain size of the primary particles of the negative electrode active material is preferably from 0.1 to 10 μm. The grain size of the secondary particles made by the aggregation of the primary particles of the negative electrode active material is desirably from 1 to 30 μm.

The specific surface area of the negative electrode active material measured by the BET adsorption method by N₂ adsorption is preferably from 1 to 30 m²/g. If the specific surface area is 1 to 30 m²/g, it is possible to sufficiently take an effective area contributing to the electrode reaction and prevent a decrease in charge and discharge efficiency and the generation of gas during storage. If the average particle size is 0.001 μm or more, it is possible to prevent the distribution of the nonaqueous electrolyte weighted toward the negative electrode side and prevent the depletion of the electrolyte in the positive electrode.

As the negative electrode conductive agent, carbon-based materials such as coke, carbon black, and graphite can be used. The average particle size of the carbon-based material is preferably 0.1 μm or more in order to suppress the generation of gas effectively. It is preferably 10 μm or less in order to form a good conductive network. The specific surface area of the carbon-based material is preferably 10 m²/g or more in order to form a good conductive network. It is preferably 100 m²/g or less in order to suppress the generation of gas effectively.

As the negative electrode binder, polyvinylidene fluoride (PVdF) with an average molecular weight of 3×10⁵ to 20×10⁵, acrylic rubber or acrylic resin can be used. The use of PVdF having a molecular weight in this range allows the peel strength between the negative electrode current collector and the negative electrode active material-containing layer to be 0.005 N/mm or more. This results in an improvement in large current characteristics. The negative electrode conductive agent having an average molecular weight in this range has a proper coating liquid viscosity and is excellent in coating property. More preferably, the average molecular weight is from 5×10⁵ to 10×10⁵.

Preferably, a surface roughness Ra (−) facing the separator 5 of the negative electrode active material containing layer 4b is set to a range of 0.1 to 0.6 μm. As a result, a wetted area with the nonaqueous electrolyte is sufficiently ensured while suppressing the side reaction by the nonaqueous electrolyte. Accordingly, it is possible to improve input-output characteristics and cycle characteristics. The surface roughness Ra (−) facing the separator 5 of the negative electrode active material containing layer 4b is preferably from 0.15 to 0.4 μm. Here, in the measurement of the surface roughness Ra (−) of the negative electrode active material containing layer 4b, the arithmetic mean roughness Ra specified by JIS B 0601 (1994) or JIS B 0031 (1994) is used.

Desirably, the density of the negative electrode 4 is set to be 2.0 g/cm³ or more but less than 2.4 g/cm³. In the case of the negative electrode 4 having a density in this range, it is possible to easily obtain the negative electrode active material containing layer 4b having the surface roughness Ra (−) of from 0.1 to 0.6 μm and prevent the deterioration of the input-output characteristics at a large current. Further, if a negative electrode active material having an average particle size 1 μm or less is used, the negative electrode 4 having the surface roughness Ra (−) of from 0.1 to 0.6 μm can be obtained by a simpler method.

3) Separator 5

A porous separator can be used for the separator 5. Examples of the porous separator include a porous film containing a material such as polyethylene, polypropylene, cellulose or polyvinylidene fluoride (PVdF); and a synthetic resin nonwoven fabric. Among them, a porous film formed of polyethylene or polypropylene or a porous film formed of both of them is preferred, because the safety of the secondary battery can be improved.

4) Nonaqueous Electrolyte

As the nonaqueous electrolyte, a liquid nonaqueous electrolyte can be used.

The liquid nonaqueous electrolyte is prepared, for example, by dissolving an electrolyte in an organic solvent.

Examples of the electrolyte include lithium salts such as lithium perchlorate (LiClO₄), lithium hexafluorophosphate (LiPF₆), lithium tetrafluoroborate (LiBF₄), arsenic lithium hexafluoride (LiAsF₆), lithium trifluoromethasulfonate (LiCF3SO₃), and lithium bis(trifluoromethylsulfonyl) imide [LiN(CF₃SO₂)₂]; and the mixtures thereof.

The electrolytes are dissolved in the organic solvent, preferably in an amount of 0.5 to 2.5 mol/L.

Examples of the organic solvent include cyclic carbonates such as ethylene carbonate (EC), propylene carbonate (PC), and vinylene carbonate (VC); linear carbonates such as dimethyl carbonate (DMC), methylethyl carbonate (MEC), and diethyl carbonate (DEC); cyclic ethers such as tetrahydrofuran (THF) and 2-methyltetrahydrofuran (2MeTHF); linear ethers such as dimethoxyethane (DME); γ-butyrolactone (BL), acetonitrile (AN), and sulfolane (SL). These organic solvents can be used alone or in the form of a mixture of two or more kinds thereof.

As the liquid nonaqueous electrolyte, a room temperature molten salt containing lithium ions can be used.

The room temperature molten salt means a salt in which at least a part of the salt exhibits a liquid form at a room temperature. The room temperature means a temperature range in which the power source is assumed to be normally operated. As for the temperature range in which the power source is assumed to be normally operated, the upper limit is about 120° C., in some cases about 60° C. The lower limit is about −40° C., in some cases about −20° C.

As the lithium salt, a lithium salt having a large potential window which is generally used for the nonaqueous electrolyte battery is used. Examples thereof include LiBF₄, LiPF₆, LiClO₄, LiCF₃SO₃, LiN(CF₃SO₂)₂, LiN(C₂F₅SO₂), and LiN(CF₃SC(C₂F₅SO₂)₃). However, they are not limited thereto. These may be used alone or two or more kinds thereof may be mixed for use.

The content of the lithium salt is from 0.1 to 3.0 mol/L, particularly preferably from 1.0 to 2.0 mol/L. If the content of lithium salt is set to 0.1 mol/L or more, the electrolyte resistance can be minimized. This results in an improvement in large current and low temperature discharging characteristics. If the content of lithium salt is set to 3.0 mol/L or less, the melting point of the electrolyte is controlled to be low, thereby enabling to maintain the liquid form at room temperature.

The room temperature molten salt is, for example, one having a quaternary ammonium organic cation or one having an imidazolium cation.

5) Positive Electrode Terminal 6

The positive electrode terminal 6 can be formed of a material having electrical stability and conductivity within a potential range of 3 V to 5 V relative to the lithium ion metal. Specific examples thereof include an aluminum alloy containing an element such as Mg, Ti, Zn, Mn, Fe, Cu and Si, and aluminum. In order to reduce a contact resistance, a material which is the same as that of the positive electrode current collector 3a is preferred.

6) Negative Electrode Terminal 7

The negative electrode terminal 7 can be formed of a material having electrical stability and conductivity within a potential range of 0.4 V to 3 V relative to the lithium ion metal. Specific examples thereof include an aluminum alloy containing an element such as Mg, Ti, Zn, Mn, Fe, Cu or Si, and aluminum. In order to reduce a contact resistance, a material which is the same as that of the negative electrode current collector 4a is preferred.

7) Case 1

As the case 1 housing the electrode group 2, a case formed of a laminate film can be used.

As the laminate film, a multilayer film having a metal foil covered with a resin film can be used. Polymers such as polypropylene (PP), polyethylene (PE), nylon, and polyethylene terephthalate (PET) can be used for the resin.

The thickness of the laminate film is desirably 0.2 mm or less.

As the case 1 housing the electrode group 2, a metal case having a thickness of 0.5 mm or less can also be used.

As the metal case, a metal can which is comprised of aluminum, an aluminum alloy, iron or stainless steel and has a square shape or a cylindrical shape can be used. The thickness of the metal case is more desirably 0.2 mm or less.

Preferable examples of the aluminum alloy forming the metal case include alloys containing elements, such as magnesium, zinc, and silicon. On the other hand, the content of transition metals such as iron, copper, nickel, and chromium is preferably 1% by mass or less. Thus, the long-term reliability in the hot environment and heat releasing property can be dramatically improved.

The metal can comprised of aluminum or an aluminum alloy has preferably an average crystal grain size of 50 μm or less. More preferably, it is 30 μm or less. Still more preferably, it is 5 μm or less. When the average crystal grain size is set to 50 μm or less, the strength of the metal can comprised of aluminum or an aluminum alloy can be dramatically increased, which allows the can to be thinner. As a result, it is possible to realize a battery that is light in weight, high in output, excellent in long-term reliability, and adapted for mounting on a vehicle.

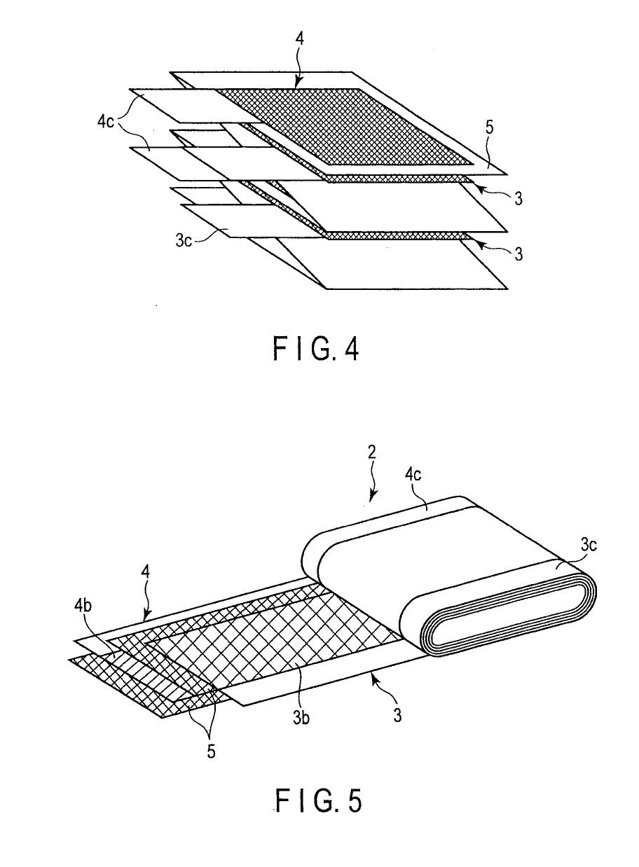

Subsequently, the battery of another example according to the second embodiment will be described with reference to FIG. 4.

In the battery according to the second embodiment, for example, as shown in FIG. 4, the electrode group 2 may comprise the separator 5 having a zigzag folded shape.

The electrode group 2 of the variant shown in FIG. 4 comprises the separator 5 having a band-like shape, folded zigzag. The negative electrode 4 having a strip shape is stacked on the top layer of the separator 5 having a zigzag folded shape. The positive electrode 3 and the negative electrode 4 which have a stripe shape are alternately inserted into a space between the face of the separator 5 facing to each other. The positive electrode tab 3c of the positive electrode current collector 3a and the negative electrode tab 4c of the negative electrode current collector 4a project in the same direction from the electrode group 2. In the electrode group 2 shown in FIG. 4, in the laminating direction of the electrode group 2, the positive electrode tabs 3c lie on top of each other and the negative electrode tabs 4c lie on top of each other. The positive electrode tab 3c and the negative electrode tab 4c do not lie on top of each other.

The positive electrode tabs of the positive electrodes 3 in the electrode group 2 shown in FIG. 4 can be mutually joined similarly to the electrode group 2 shown in FIGS. 1 and 2. The negative electrode tabs of the negative electrodes 4 in the electrode group 2 shown in FIG. 4 can be mutually joined. As described above, the surface roughness Ra₁ as for the positive electrode tabs and the negative electrode tabs is small. Thus, mutually joining of the positive electrode tabs and mutually joining of the negative electrode tabs can be carried out with sufficient join strength even if the low power for ultrasonic welding is applied.

The positive electrode tabs 3c mutually joined can be electrically connected to the positive electrode terminal (not shown) similarly to the battery shown in FIGS. 1 and 2. The negative electrode tabs 4c mutually joined can be electrically connected to the negative electrode terminal (not shown) similarly to the battery shown in FIGS. 1 and 2.

FIG. 4 shows the electrode group 2 comprising two sheets of the positive electrodes 3 and two sheets of the negative electrodes 4. However, the number of sheets of the positive electrode 3 and the negative electrode 4 can be freely changed according to the purpose and application. The directions where the positive electrode tabs 3c and the negative electrode tabs 4c project from the electrode group 2 do not need to be the same as shown in FIG. 4. For example, it may be a direction forming an angle of about 90° or 180°.

Subsequently, another example of the battery according to the second embodiment will be described with reference to FIG. 5.

The battery according to the second embodiment can comprise a coiled type electrode group 2 as shown in FIG. 5.

The electrode group 2 shown in FIG. 5 has a structure in which the beltlike positive electrode 3 and the beltlike negative electrode 4 are coiled whiling sandwich the beltlike separator 5 therebetween. The positive electrode 3, the negative electrode 4, and the separator 5 are coiled whiling shifting the positions of the positive electrode 3 and the negative electrode 4 so that the positive electrode tab 3c projects from the separator 5 in the coiling axial direction of the electrode group 2, and the negative electrode tab 4c projects from the separator 5 in the opposite direction thereto.

In the electrode group 2 shown in FIG. 5, the coiled positive electrode tab 3c is fixed with, for example, a holding member and the positive electrode tab 3c thus fixed is subjected to ultrasonic welding so that facing portions in the coiled positive electrode tab 3c can be joined. As described above, the surface roughness Ra₁ of the positive electrode tab 3c is small. Thus, joining of the surfaces of the coiled positive electrode tab 3c can be achieved with sufficient join strength even if the low power for ultrasonic welding is applied.

A stack in a state in which the coiled positive electrode tab 3c and the positive electrode terminal (not shown) are fixed with a holding member is subjected to ultrasonic welding so that the positive electrode 3 can be electrically connected to the positive electrode terminal.

In the electrode group 2 shown in FIG. 5, the coiled negative electrode tab 4c is fixed with, for example, a holding member and the negative electrode tab 4c thus fixed is subjected to ultrasonic welding so that facing portions in the wound negative electrode tab 4c can be joined. As described above, the surface roughness Ra₁ of the negative electrode tab 4c is small. Thus, mutually joining of the surfaces of the coiled negative electrode tab 4c can be achieved with sufficient join strength even if the low power for ultrasonic welding is applied.

A stack in a state in which the coiled negative electrode tab 4c and the negative electrode terminal (not shown) are fixed with a holding member is subjected to ultrasonic welding so that the negative electrodes 4 can be electrically connected to the negative electrode terminal.

As described above, in the case of the electrode group 2 shown in FIG. 5, a plurality of sites of a positive electrode current collector 3 can be joined and a plurality of sites of a negative electrode current collector 4 can be joined. That is, the battery according to the second embodiment can comprise the electrode group 2 in which the sites of one current collector are joined.

The battery according to the second embodiment has been described taking the example of the nonaqueous electrolyte battery. However, the battery according to the second embodiment is not limited to the nonaqueous electrolyte battery and may be a battery using an aqueous solution as an electrolyte.

As described above, the battery according to the second embodiment includes the electrode according to the first embodiment. Thus, according to the second embodiment, there can be provided a battery having excellent battery characteristics and excellent reliability of mutually joining of electrode tabs.

### Third Embodiment

According to the third embodiment, there is provided a battery pack includes one or more batteries. The battery or batteries included in the battery pack is or are the battery according to the second embodiment.

The battery pack according to the third embodiment can include a plurality of the batteries according to the second embodiment. Further, the battery pack according to the third embodiment can include an energizing terminal to an external device.

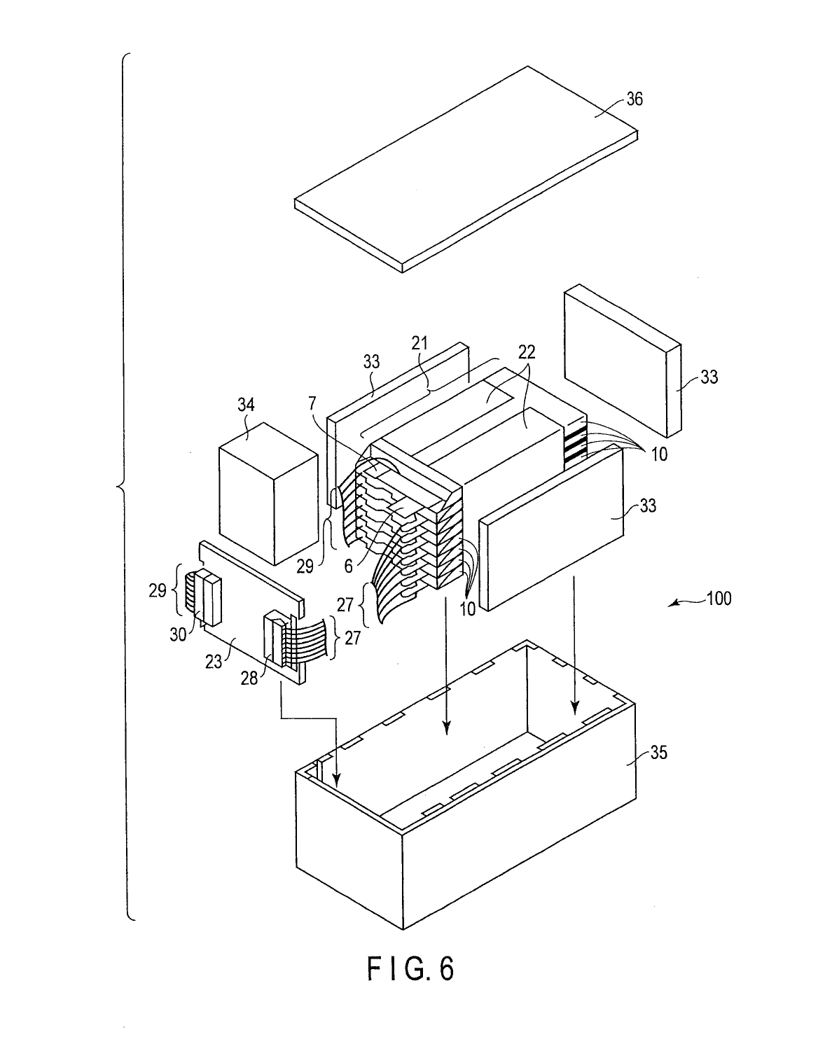

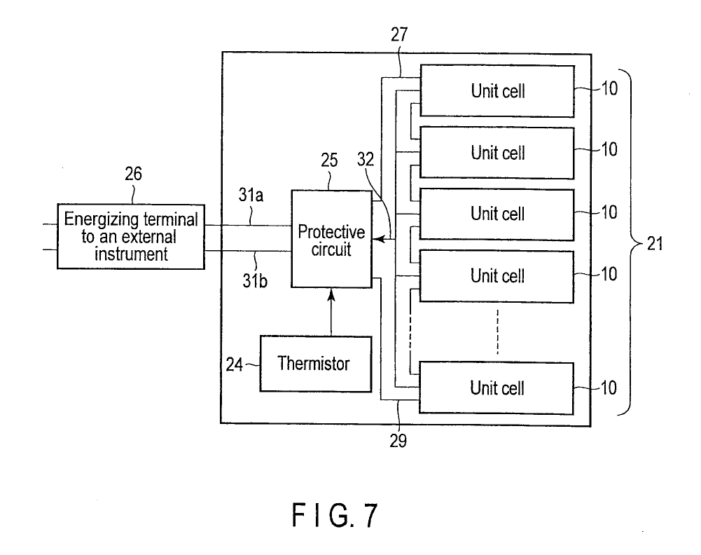

Hereinafter, an example of the battery pack according to the third embodiment will be described in detail with reference to FIGS. 6 and 7.

FIG. 6 is a schematic exploded perspective view of an example of a battery pack according to a third embodiment. FIG. 7 is a block diagram showing an electric circuit of the battery pack shown in FIG. 6.

A battery pack 100 shown in FIGS. 6 and 7 comprises a plurality of the batteries (unit cells) 10 according to the first embodiment. In the batteries 10, the positive electrode terminal 6 and the negative electrode terminal 7 project in the same direction. The batteries 10 are stacked in a state that the projected sides of the positive electrode terminal 6 and the negative electrode terminal 7 are aligned. As shown in FIGS. 5 and 6, the batteries 10 are connected in series to form a battery module 21. As shown in FIG. 6, the battery module 21 is integrated with an adhesive tape 22.

A printed wiring board 23 is disposed on the side surface in which the positive electrode terminal 6 and the negative electrode terminal 7 project. A thermistor 24, a protective circuit 25, and an energizing terminal 26 to an external device as shown in FIG. 7 are mounted on the printed wiring board 23.

As shown in FIGS. 6 and 7, wirings 27 at the positive-electrode side of the battery module 21 are electrically connected to a connector 28 at the positive-electrode side of the protective circuit 25 of the printed wiring board 23. Wirings 29 at the negative electrode side of the battery module 21 are electrically connected to a connector 30 at the negative electrode side of the protective circuit 25 of the printed wiring board 23.

The thermistor 24 is configured to detect the temperature of the batteries 10. The detection signal of the temperature of the battery 10 is sent from the thermistor 24 to the protective circuit 25. The protective circuit 25 can interrupt a plus-side wiring 31a and a minus-side wiring 31b between the protective circuit 25 and the energizing terminal to an external device under a predetermined condition. The predetermined condition is, for example, the condition in which the detection temperature of the thermistor 24 becomes a predetermined temperature or more or the condition in which the over-charge, over-discharge, and over-current of the batteries 10 are detected. This check method is performed on each of the batteries 10 or the whole battery module 21. When each of the batteries 10 is checked, the cell voltage may be detected or positive electrode or negative electrode potential may be detected. The check of the whole battery module 21 can be performed by inserting a lithium electrode used as a reference electrode into each of the batteries 10. In the case of FIG. 7, wirings 32 for voltage detection are connected to the batteries 10 and detection signals are sent to the protective circuit 25 through the wirings 32.

As for the battery module 21, protective sheets 33 formed of rubber or resin are disposed on three side surfaces other than the side surface where the positive electrode terminal 6 and the negative electrode terminal 7 project. A protective block 34 comprised of rubber or resin is disposed between the side surface where the positive electrode terminal 6 and the negative electrode terminal 7 project and the printed wiring board 23.

The battery module 21 is housed in a housing container 35 together with each of the protective sheets 33, the protective block 34, and the printed wiring board 23. That is, the protective sheets 33 are arranged on both internal surfaces in a long side direction of the housing container 35 and on one of the internal surface at the opposite side in a short side direction. The printed wiring board 24 is arranged on the other internal surface in a short side direction. The battery module 21 is located in a space surrounded by the protective sheets 33 and the printed wiring board 24. A lid 36 is attached to the upper surface of the housing container 35.

In order to fix the battery module 21, a heat-shrinkable tape may be used in place of the adhesive tape 22. In this case, the battery module is bound by placing the protective sheets on the both sides of the battery module, revolving the heat-shrinkable tube, and thermally shrinking the heat-shrinkable tube.

The batteries 10 shown in FIGS. 6 and 7 are connected in series. However, in order to increase the battery capacity, the batteries may be connected in parallel. Of course, the assembled battery pack can be connected in series or in parallel.

The form of the battery pack can be appropriately changed according to the use.

As the use of the battery pack according to the third embodiment, the use to expect cycle characteristics in high current characteristics is preferred. Specifically, the use of the battery pack for power sources for digital cameras, the use of the battery pack for vehicles such as two- or four-wheel hybrid electric vehicles, two- or four-wheel electric vehicles, and assisted bicycles or the like are listed. Particularly, automobile use is preferred.

As described above, the battery pack according to the third embodiment includes the battery according to the second embodiment. As described above, the battery according to the second embodiment has excellent battery characteristics and excellent reliability of mutually joining of electrode tabs. Therefore, the battery pack according to the third embodiment which includes such a battery can improve battery characteristics such as output characteristics, rapid charge characteristics, and charge and discharge cycle characteristics and can ensure long-term reliability related to the above characteristics.

### EXAMPLES

Hereinafter, the present invention will be described more in detail referring to the examples. However, the present invention is not limited to the following examples unless departing from the spirit of the present invention.

### Example 1

In Example 1, the same batteries 10 as those shown in FIGS. 1 and 2 were produced by the following procedure.

<Production of Positive Electrode 3>

90% by mass of lithium cobalt oxide (LiCoO₂) powder as an positive electrode active material, 3% by mass of acetylene black and 3% by mass of graphite as conductive agents, and 4% by mass of polyvinylidene fluoride (PVdF) as a binder were added to N-methyl pyrrolidone (NMP), which was mixed to prepare slurry.

The obtained slurry was applied to both sides of a positive electrode current collector 3a formed of aluminum foil. The aluminum foil had a thickness of 15 μm and an average crystal grain size of 30 μm. Further, the surface roughness Ra₂ of the aluminum foil was 0.40 μm because of surface roughening by electrolytic etching. The slurry was applied to a part of both sides of the positive electrode current collector 3a so as to form a portion uncoated with the slurry.

The positive electrode current collector 3a coated with the slurry was dried to obtain a positive electrode active material containing layer 3b which was supported by a part of the positive electrode current collectors 3a. Thereafter, the positive electrode active material containing layer 3b was pressed.

After the press, the positive electrode current collector 3a supporting the positive electrode active material containing layer 3b was punched to obtain a positive electrode 3 having the structure shown in FIGS. 3A and 3B. The positive electrode 3 obtained by punching comprised the positive electrode current collector 3a having a rectangular main portion and a narrow portion extended from one side of the main portion and having a width smaller than that of the main portion. The main portion of the positive electrode current collector 3a supported the positive electrode active material containing layer 3b. On the other hand, the narrow portion of the positive electrode current collector 3a did not retain the positive electrode active material containing layer 3b.

Subsequently, the narrow portion of the positive electrode current collector 3a was pressed using a hammer to adjust the surface roughness Ra₁ to 0.15 μm.

The main portion of the positive electrode current collector 3a of the positive electrode 3 thus produced supported the positive electrode active material containing layer 3b and the surface roughness Ra₂ was larger than that of the narrow portion. In other words, the surface of the main portion of the positive electrode current collector 3a is the second region.

The narrow portion of the positive electrode current collector 3a of the positive electrode 3 thus produced did not support the positive electrode active material containing layer 3b, and the surface roughness Ra₁ was smaller than that of the main portion. In other words, the narrow portion of the positive electrode current collector 3a has the surface which is the first region and serves as a positive electrode tab 3c.

The electrode density of the positive electrode 3 was 3.0 g/cm³. The surface roughness Ra (+) of the positive electrode active material containing layer 3b of the positive electrode 3 was 0.15 μm.

<Production of Negative Electrode 4>

As a negative electrode active material, TiO₂(B) having an average grain size of 10 μm and an average lithium absorption and release potential of 2.3 V (vs. Li/Li⁺) was prepared. A particle size of the negative electrode active material was measured by using a laser diffractometry type particle size distribution measurement device (Microtrack MT3000 manufactured by Nikkiso Co., Ltd.). The negative electrode active material, acetylene black as a conductive material, and polyvinylidene fluoride (PVdF) having an average molecular weight of 4×10⁵ as a binder were added to a N-methyl-pyrrolidone (NMP) solution at a weight ratio of 95:2.5:2.5, which was mixed to prepare slurry.

The obtained slurry was applied to both sides of a negative electrode current collector 4a formed of aluminum foil. The aluminum foil had a thickness of 15 μm and an average crystal grain size of 30 μm. Further, the surface roughness Ra₂ of the aluminum foil was 0.40 μm because of surface roughening by electrolytic etching. The slurry was applied to a part of both sides of the negative electrode current collector 4a so as to form a portion uncoated with the slurry.

The negative electrode current collector 4a coated with the slurry was dried to obtain a negative electrode active material containing layer 4b which was supported by a part of the negative electrode current collector 4a. Thereafter, the negative electrode active material containing layer 4b was pressed.

After the press, the negative electrode current collector 4a supporting the negative electrode active material layer 4b was punched to obtain a negative electrode 4. The negative electrode 4 obtained by punching comprised the negative electrode current collector 4a having a rectangular main portion and a narrow portion extended from one side of the main portion and having a width smaller than that of the main portion. The main portion of the negative electrode current collector 4a supported the negative electrode active material containing layer 4b. On the other hand, the narrow portion of the negative electrode current collector 4a did not support the negative electrode active material containing layer 4b.

Subsequently, the narrow portion of the negative electrode current collector 4a was pressed using a hammer to adjust the surface roughness Ra₁ to 0.15 μm.

The main portion of the negative electrode current collector 4a of the negative electrode 4 thus produced supported the negative electrode active material containing layer 4b and the surface roughness Ra₂ was larger than that of the narrow portion. In other words, the surface of the main portion of the negative electrode current collector 4a is the second region.

The narrow portion of the negative electrode current collector 4a of the negative electrode 4 thus produced did not retain the negative electrode active material containing layer 4b, and the surface roughness Ra₁ was smaller than that of the main portion. In other words, the narrow portion of the negative electrode current collector 4a has the surface which is the first region and serves as a negative electrode tab 4c.

The electrode density of the negative electrode 4 was 2.0 g/cm³.

<Production of Electrode Group 2>

300 sheets of the positive electrodes 3 and 300 sheets of the negative electrodes 4 were produced in the above manner.

Subsequently, the positive electrodes 3 and the negative electrodes 4 were alternately stacked while sandwiching high-density polyethylene as the separator 5 therebetween. In this case, they were stacked so that the positive electrode tabs 3c and the negative electrode tabs 4c projected from an electrode group stack 2.

Subsequently, the positive electrode tabs 3c projected from the electrode group stack 2 were fixed with a holding member. The fixed tabs were mutually joined by ultrasonic welding under the following conditions: collapse: 0.24 mm; hold time: 0.1 S; trigger pressure: 200 N; and amplitude: 66%. As a result, a plurality of positive electrodes 3 electrically connected to one another were obtained. Similarly, the negative electrode tabs 4c projected from the electrode group stack 2 were fixed with a holding member. The fixed tabs were mutually joined by ultrasonic welding under the following conditions: collapse: 0.24 mm; hold time: 0.1 S; trigger pressure: 200 N; and amplitude: 66%. As a result, a plurality of negative electrodes 4 electrically connected to one another were obtained. The electrode group 2 was produced in this manner.

Subsequently, in the electrode group 2 thus produced, the positive electrode terminal 6 was electrically connected to the positive electrodes 3 electrically connected to one another. On the other hand, the negative electrode terminal 7 was electrically connected to the negative electrodes 4 electrically connected to one another.

The electrode group 2 electrically connected to the positive electrode terminal 6 and the negative electrode terminal 7 was housed in the case 1 formed of a laminate film in a state in which a part of the positive electrode terminal 6 and a part of the negative electrode terminal 7 are exposed outside.

Subsequently, the case 1 was heat-sealed so as to leave a part of the periphery thereof. Then, a nonaqueous electrolyte was housed in the case 1 through the portion of the case 1 which was not heat-sealed to allow the electrode group 2 to be impregnated with the nonaqueous electrolyte. Finally, the portion of the case 1 which was not heat-sealed was heat-sealed to obtain a battery 10.

### Examples 2 and 3 and Comparative Example 1

In Examples 2 and 3 and Comparative example 1, batteries 10 were produced in the same manner as described in Example 1 except that the positive electrode 3 comprising the positive electrode current collector 3a having the surface roughness Ra₁ of the first region and the surface roughness Ra₂ of the second region as shown in Table 1 and the negative electrode 4 comprising the negative electrode current collector 4a having the surface roughness Ra₁ of the first region and the surface roughness Ra₂ of the second region as shown in Table 1 were produced.

[Peel Strength]

The peel strength of the batteries 10 of Examples 1 to 3 and Comparative example 1 was measured. The peel strength was measured at a peeling angle of 360 degree and a peeling rate of 2 cm/min. The results are shown in Table 1 below.

[Capacity-Retention]

The batteries 10 of Examples 1 to 3 and Comparative example 1 were subjected to perform a high temperature acceleration test, specifically under an environment of 50° C. or less, and a capacity retention measurement after 50 cycles in each of which 1 C charge and discharge were performed in a range from SOC 0 to 100%. The results are shown in Table 1 below.

TABLE 1

| | | | | High |
|---|---|---|---|---|
| | | | | temperature |
| | Surface | Surface | | accelerated |
| | roughness | roughness | | test - |
| | Ra₁ (μm) | Ra₂ (μm) | | Capacity- |
| | of the | of the | Peel | retention |
| | first | second | strength | (%) after |
| | region | region | (g/cm) | 50 cycles |
| Example 1 | 0.15 | 0.40 | 32 | 45.6 |
| Example 2 | 0.15 | 1.00 | 48 | 63.5 |
| Example 3 | 0.15 | 1.30 | 51 | 77.0 |
| Comparative | 0.15 | 0.15 | 27 | 22.6 |
| Example 1 | | | | |

The results of Table 1 show that the peel strength of the batteries 10 of Examples 1 to 3 was superior to that of the battery of Comparative example 1 and exhibited a high capacity retention after 50 cycles of the high temperature accelerated test. This is assumed as follows. In the batteries 10 of Examples 1 to 3, the surface roughness Ra₁ of each of a first region 3c not supporting the positive electrode active material containing layer 3b on the surface of the positive electrode current collector 3a and a first region 4c not supporting the negative electrode active material containing layer 4b on the surface of the negative electrode current collector 4a was small, and thus sufficient join strength could be obtained even if the low power for ultrasonic welding was applied. The surface roughness Ra₂ of each of the second region supporting the positive electrode active material containing layer 3b on the surface of the positive electrode current collector 3a and the second region supporting the negative electrode active material containing layer 4b on the surface of the negative electrode current collector 4a was large, and thus the adhesion between the current collector and the active material could be improved in the positive electrode and the negative electrode.

On the other hand, the capacity retention after 50 cycles of the high temperature accelerated test of the battery of Comparative example 1 was lower than those of the batteries of Examples 1 to 3. This is assumed because, in the positive electrode and the negative electrode, the surface roughness of the region supporting the active material on the surface of the current collector was small, and thus the adhesion between the current collector and the active material was low.

Further, the capacity retention after 50 cycles of the high temperature accelerated test of the batteries of Examples 2 and 3 were higher than that of the battery of Example 1. This is assumed because, in the batteries of Examples 2 and 3, the surface roughness of the second region supporting the active material-containing layer of the current collector was higher than that of Example 1, and thus the adhesion between the current collector and the active material-containing layer could be further improved.

Further, the capacity retention of the battery of Example 3 was higher than that of Example 2. Similarly, this is assumed because, in the battery of Example 3, the surface roughness of the second region supporting the active material-containing layer of the current collector was higher than that of Example 2, and thus the adhesion of the current collector and the active material-containing layer could be further improved.

Further, the results of Table 1 show that the peel strength of the battery of Comparative example 1 is inferior to that of the batteries of Examples 1 to 3. Further, the results of Table 1 show that the peel strength of the batteries of Examples 2 and 3 is superior to that of the battery of Example 1. In other words, the results of Table 1 show that even if the batteries have the same surface roughness Ra₁, the battery having a large difference between the surface roughness Ra₁ and the surface roughness Ra₂ has excellent peel strength.

That is, in the battery according to at least one of the embodiments and the examples, the surface roughness Ra₁ of the first region which does not support the active material-containing layer of the current collector included in the electrode is smaller than the surface roughness Ra₂ of the second region which supports the active material-containing layer. Thus, according to at least one of the embodiments and the examples, there can be provided a battery having excellent battery characteristics and excellent reliability of mutually joining of electrode tabs.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electrode comprising:
an active material-containing layer; and
a current collector comprising a first region not supporting the active material-containing layer and having a surface roughness of Ra₁, and a second region supporting the active material-containing layer and having a surface roughness of Ra₂, wherein the surface roughness Ra₁ of the first region is smaller than the surface roughness Ra₂ of the second region.

2. The electrode according to claim 1, wherein
a thickness T₁ of the current collector in the first region is smaller than a thickness T₂ of the current collector in the second region.

3. The electrode according to claim 1, wherein
the surface roughness Ra₁ of the first region is not less than 0.01 μm but not more than 0.4 μm.

4. The electrode according to claim 1, wherein
the surface roughness Ra₂ of the second region is more than 0.4 μm but not more than 5 μm.

5. The electrode according to claim 1, wherein
the current collector is an electrolytically-etched foil.

6. The electrode according to claim 1, wherein
the current collector comprises: (a) at least one metal selected from the group consisting of aluminum, copper, nickel, titanium, and iron; (b) stainless steel; (c) alloy containing at least one selected from the group consisting of aluminum, copper, nickel, titanium, and iron; or (d) a clad foil containing at least one selected from the group consisting of aluminum, copper, nickel, titanium, iron, and stainless steel.

7. A battery comprising:
one or more electrodes, each of which comprises:
an active material-containing layer; and
a current collector comprising a first region not supporting the active material-containing layer and having a surface roughness of Ra₁, and a second region supporting the active material-containing layer and having a surface roughness of Ra₂, wherein the surface roughness Ra₁ of the first region is smaller than the surface roughness Ra₂ of the second region.

8. The battery according to claim 7, comprising a plurality of the electrodes, and wherein the first region of the current collector of each of the electrodes serves as an electrode tab, and a plurality of first regions are joined together by ultrasonic welding.

9. A battery pack comprising:
one or more batteries, each of which comprises:
an electrodes comprises:
an active material-containing layer; and
a current collector comprising a first region not supporting the active material-containing layer and having a surface roughness of Ra₁, and a second region supporting the active material-containing layer and having a surface roughness of Ra₂, wherein the surface roughness Ra₁ of the first region is smaller than the surface roughness Ra₂ of the second region.

10. The battery pack according to claim 9, comprising a plurality of the batteries, wherein the plurality of the batteries are electrically connected to each other in series, in parallel or in the combination thereof.

11. The battery pack according to claim 9, further comprising:
a protective circuit configured to detect a voltage of the batteries.
